(19) United States
(12) Patent Application Publication
(10) Pub. No.: US 2022/0300650 A1
(43) Pub. Date: Sep. 22, 2022

(54) COGNITIVE FRAMEWORK FOR PRIVACY-DRIVEN USER DATA SHARING

(71) Applicant: International Business Machines Corporation, Armonk, NY (US)

(72) Inventors: Vijay Ekambaram, Chennai (IN); Harish Bharti, Pune (IN); Rakesh Shinde, Maharashtra (IN); ABHAY KUMAR PATRA, PUNE (IN); Sandeep Sukhija, Rajasthan (IN)

(21) Appl. No.: 17/207,903

(22) Filed: Mar. 22, 2021

(51) Int. Cl. G06F 21/62; H04L 29/06; G06F 16/25; G06N 3/04; G06N 3/08

(52) U.S. Cl. CPC G06F 21/6254; H04L 63/0421; G06F 16/258; G06N 3/0454; G06N 3/088

(57) ABSTRACT

A processor may be configured to perform operations that include computing a benefit-to-resource score for a dataset and selecting an autoencoder architecture based on the benefit-to-resource score. The autoencoder architecture may balance minimizing reconstruction loss with minimizing required storage space based on the benefit-to-resource score. The operations performed by the processor may further include transforming the dataset into transformed data with a transformation function based on the autoencoder architecture and storing the transformed data in a user space.

### BACKGROUND

The present disclosure relates to data privacy, and more specifically, to protecting data while generating tailored interactions between users.

Online service has become more commonplace. Many users are hesitant to provide information to online due to privacy concerns. Thus, online providers consistently seek ways to protect user data.

### SUMMARY

Embodiments of the present disclosure include a method, system, and computer program product for privacy-driven data sharing. The embodiments may include computing, by a processor, a benefit-to-resource score for a dataset. An autoencoder architecture may be selected based on the benefit-to-resource score wherein the autoencoder architecture balances minimizing reconstruction loss and minimizing required storage space based on the benefit-to-resource score. The dataset may be transforming into transformed data with a transformation function based on said autoencoder architecture. The transformed data may be stored in a user space.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a communication flow of representative components of a system in accordance with some embodiments of the present disclosure.

FIG. 2 depicts an orchestration flow for privacy-driven data sharing in accordance with some embodiments of the present disclosure.

FIG. 3 illustrates a privacy-driven data sharing system in accordance with some embodiments of the present disclosure.

FIG. 4 depicts a data sharing method using dimension reduction in accordance with some embodiments of the present disclosure.

FIG. 5 illustrates a cloud computing environment according to an embodiment of the present invention.

FIG. 6 depicts abstraction model layers according to an embodiment of the present invention.

FIG. 7 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to data privacy; more particular aspects relate to protecting user information and other data while generating a tailored interaction between users (e.g., a user [product purchaser] and various product providers).

Online product providers may include organizations that provide products in an online marketplace (e.g., the Internet). Online product providers (alternatively, products providers, or providers) may include goods providers, services providers, or other various products. Product providers may provide goods, such as electronics, clothing, textiles, and automobile parts. For example, a provider may be a goods provider that runs an online retail store selling goods to users. Product providers may provide online services, such as social media services, and web-hosting services. Product providers may provide real-world services, such as lawn mowing, house cleaning, and automobile repair. For example, a provider may be a services provider that runs an online portal offering web-hosting services.

Providers may operate by receiving requests from a user through a user device, such as a smartphone or a laptop computer. The providers may parse a request as part of a fulfillment of the request. For example, an online retail may receive a request with one or more parameters from a user device of the user: a user may be interested in purchasing a shirt, and the online retailer may parse parameters from the user device that relate to a size, color, brand, team affiliation, and the like regarding shirts. The user may be looking for a small green shirt to wear to the beach, and the user device may transmit parameters indicating the size small, the color green, and the seasonality summer. In response, the provider may return a list of shirts matching the parameters.

There may be benefits to the data received by the provider. First, the provider may use the data directly to benefit future interactions with the user. For example, the provider may save user information of the user, such as the name, address, and purchase history with the user's permission. The provider may perform one or more algorithms on the user information to generate insights about the data. An insight may be one or more new data elements that include information that did not exist in the received data provided by the user or data that was created solely based on analysis of the received data and without further input from a user. For example, if a user purchases a first item of clothing (e.g., a jacket) with a certain size of a first brand and a second item of clothing (e.g., a second jacket) with a second size of a second brand, an insight may be new data; in this example, the new data may be a range of clothing sizes that a user may prefer, a time of day that a user prefers to purchase a particular item, a location within a region (such as a location relative to a home, e.g., a living room, et cetera) where a user prefers to purchase clothing. Algorithms may be methods, processes, and the like used to analyze the data of the user information and to draw conclusions regarding the data. For example, the provider may generate an insight to indicate a user prefers to purchase pink shirts in the fall months of a calendar year.

Second, the provider may use the data directly to benefit interactions with other users. For example, the provider may gather data regarding a plurality of users that have sent requests from their user devices; the provider may perform analysis using an algorithm to generate an insight that many users prefer to purchase a coat in the second week of November each year.

Moreover, the product providers can gain additional benefits from the requests. Providers may benefit indirectly (e.g., by earning money) from the user information, the insights generated by the information, and/or other data of or related to one or more users. A first way a provider may indirectly benefit is by selling the data to other providers. For example, a first online retail may have in place an agreement with a second online retailer whereby if the first online retailer collects or generates any data for a user then the first online retailer will share the data with a second online retailer. In such an embodiment, the user may be notified of the agreement and can choose to not have the data provided to the second online retailer.

There may be many drawbacks to the user regarding the sharing of their information and insight generation or any other data related to the user. For example, information may be of a sensitive nature to a user (e.g., date-of-birth, SSN, et cetera). In another example, a user may find it undesirable to have information shared in and of itself. Specifically, a user may not identify any particular information in and of itself sensitive or private, but the user may find it undesirable that other entities such as providers and advertisers have access to, and are, collecting and using the information related to the user.

A user may withdraw from using online services as a result of attempting to prevent the sharing of any data with providers. A user may not want to participate in data collection or using certain online providers. Consequently, online providers may find themselves having more difficulty in drawing customers. In some instances, users may install third-party utilities that block or attempt to block collection of data. These third-party utilities may be unvetted or unsafe. For example, the third-party utilities may use excessive processing power on a user device or may consume larger amounts of random-access memory (RAM) on the user device and, as a result, the third-party utilities may cause slowdowns and/or data loss on the user device.

Additionally, variously regulating entities, such as governments and other rule-making authorities, have generated laws and regulations requiring user information be neither collected nor shared or otherwise not used in various circumstances. For example, the General Data Protection Regulation (GDPR) enacted in the European Union may require providers and advertisers to not collect or view certain user information and/or generated insights. Accordingly, in some instances, to comply with the GDPR, advertisers and product providers may run their online operations in a less efficient manner to comply with the regulation. For example, a provider run an online store without personalizing a result of a user-initiated request. This may lead to a user device receiving more results, slowing the processing of a user device, and/or increasing the network bandwidth required to provide results from a product provider. Similarly, untailored advertisements received from an advertiser may result in slower responsiveness from a user device and/or may increase memory usage.

Insight generation in private cloud environments (IGPCE) may enable compliance with regulations while delivering increased performance. IGPCE may operate to provide for personalization of a user's experience across various online product providers and increase the customization of advertising or other offerings provided to a user without reducing the privacy of the user. IGPCE may facilitate the operations of highly personalized services while increasing the trust a user may have to share their consumption habits and other personal information. IGPCE may operate while complying with more stringent data handling requirements, such as being compliant with GDPR.

Further, IGPCE may facilitate users to control both the access and storage of user data as well as the insights that are generated about them, which may increase the likelihood a user agrees to share user information, personalize their data, and/or allow for data-based insights to be generated based on the user information. The use of an IGPCE may improve quality of life functionality for a user. For example, a user may receive tailored offerings, advertising, and reduced search results when navigating various online providers. Consistently with this more tailored online experience, how actual user information is shared with providers may be limited. Further, in some embodiments, by utilizing an IGPCE as an intermediary between a user device and an online product provider to consume products (e.g., goods and services), some or all user data may not be shared with any of the providers.

An IGPCE may operate by detecting user-initiated requests from user devices that are owned and controlled by the user. The IGPCE may perform analysis on the user-initiated requests as well as other user information that is provided to the IGPCE. For example, a user may log in or sign up for service provided through the IGPCE and may thus receive an account and be assigned a private cloud. The user may provide user information such as their name, age, personal mailing address, et cetera to the IGPCE. The private cloud of the IGPCE assigned to the user may be configured to store user information (e.g., data related to the user).

In some embodiments, the private cloud may be configured to store insights that are generated about the user. For example, a user using an IGPCE may have the private cloud indirectly browse for goods from a product provider, the private cloud may collect one or more parameters of the user-initiated requests directed toward the product provider. The private cloud may also collect a purchase decision related to the goods and/or services offered by the product provider (e.g., that the user purchased something). The private cloud may perform an analysis related to the information of the purchase as well as analyze the user-initiated request to generate one or more insights (e.g., the user prefers long jackets). The generated insights may be stored in the private cloud and used for further online interactions. For example, if a subsequent request for goods or services to a product provider is detected, the private cloud may alter provider responses (e.g., rearrange and/or filter results of a provider response) based both on the one or more parameters of a user-initiated request as well as on previously generated insights. For example, if a user previously looked for blue socks, then a new search for shorts may be filtered based on the color blue.

The private cloud of an IGPCE may perform a smart orchestration to analyze information related to a user and user searches. Specifically, the IGPCE may detect that a device belonging to the user is transmitting a user-initiated request to a product provider. The private cloud may intercept the user-initiated request and perform analysis on the request to determine certain user-information of the user. The private cloud of the IGPCE may remove certain parameters from the user-initiated request to create an anonymized request and send the anonymized request to the product provider. The private cloud may receive a provider response from the product provider, generate a targeted response based on the parameters of the user-initiated request and the results in the provider response, and transmit the targeted response to the device the user used to transmit the original request.

In an example, a user may be looking for a pair of shoes on a retail website, and the user may transmit a request for “size 9 tennis shoes” to the retail website. The private cloud may intercept the request from the device, analyze it for user information (e.g., a shoe size specified in the one or more parameters of the request from the user device), and anonymize the request. The private cloud may anonymize the request by removing certain parameters such as by using “size 7 to size 10 shoes” as the only parameters. The anonymized request may be sent on behalf of the user via the private cloud, which may transmit the request for “shoes” to an online shoe retailer and receive a list of shoes matching the “size 7 to size 10” anonymized request. The private cloud may generate a targeted response by filtering out all results that are not size “9” shoes or of a type other than “tennis shoes.” The private cloud may transmit the “size 9 tennis shoes” response to the user via the user device, completing the personalized request while preserving user data privacy and complying with data privacy regulations.

In some embodiments, a portable component of the IGPCE may be running on a user device. The portable component may be a plugin (e.g., a browser plugin), a background program running as a part of a software environment of the device (e.g., a daemon or job), or an algorithm designed to perform searches on product providers and generate insights based on user-initiated requests. The portable component may perform the detection of user-initiated requests.

A portable component may operate by preventing product providers from receiving user-initiated requests. For example, the portable component may intercept user-initiated requests from an outbound request queue, network stack, or other transmission component of a user device. The portable component may transmit the requests to a private cloud of the IGPCE and receive targeted responses from the private cloud.

A portable component may, for example, be based on the website or online portal of a product provider. The portable component may automatically pull various data features which may enable the IGPCE to improve insights; such data may have otherwise been generated by the product provider. Specifically, the private cloud (e.g., an orchestration engine running on the private cloud) may identify a type of product requested (in the one or more parameters of the user-initiated query) based on the product provider or insights of the user; the private cloud may further identify a specific insight generating engine (e.g., an algorithm) for use by the portable component. For example, if a user is browsing for shirts on a first online retailer, the orchestration engine of the private cloud of the IGPCE may identify a particular specific insight generating engine capable of performing a particular type of search on the first online retailer and generating insights based on that retailer.

The offloading of insight generation from the private cloud to a portable component of an IGPCE executed on a user device may include technical benefits to the user. For example, processing power for insight generation may be distributed for a plugin running on a smartphone and may offload that processing power from the servers that host the IGPCE (e.g., a component of the smartphone relieves a processing performed by the servers). Offloading in the aggregate may save on computing resources (e.g., processing cycles and memory space).

In some embodiments, an IGPCE may operate without a portable component installed on the device of the user. For example, a private cloud may host an online portal, website, or other network destination for a user to connect to and browse product providers. The network destination may be contained, or all network traffic may flow through the network destination. The private cloud may monitor the traffic to detect user-initiated requests and intercept requests to prevent the requests from leaving the private cloud.

An IGPCE may also provide a user with full control of their user information. For example, a user may receive a request to share data or permit the product provider to generate insights based upon the data of a user from a particular product provider. The user may respond to the request with a denial response; the denial response may be a request to not share information with the product provider. As a result of the denial response, the IGPCE may decline sharing user information and initiate operation through a private cloud. For example, if a user provides a denial response via smartphone app, the portable component of the IGPCE may initiate operation through a private cloud. In another example, if a user provides a denial response while on the private cloud, the IGPCE may prevent providing user information to the product provider.

The IGPCE may be configured to operate transparently. For example, if a user navigates to an online product provider to begin searching for a particular good or service, the product provider may request the share of data or permission of the product provider to generate insights based on user information provided by the user device. The user may respond to the request by granting permission. The grant of permit may cause the user device to communicate directly with the product provider to facilitate browsing and searching for goods and services. Later, a user may decide to no longer share information with the product provider, navigate through the user device to the relevant settings, and select to use a particular product provider without providing information; in response, the portable component on the user device may begin operating without providing user information to the product provider, instead communicating via the private cloud of the IGPCE.

Embodiments of the present disclosure include a method for privacy-driven data sharing. The method may include computing a benefit-to-resource score for a dataset and selecting an autoencoder architecture based on the benefit-to-resource score. The autoencoder architecture may balance minimizing reconstruction loss with minimizing required storage space based on the benefit-to-resource score. The method may further include transforming the dataset into transformed data with a transformation function based on the autoencoder architecture and storing the transformed data in a user space.

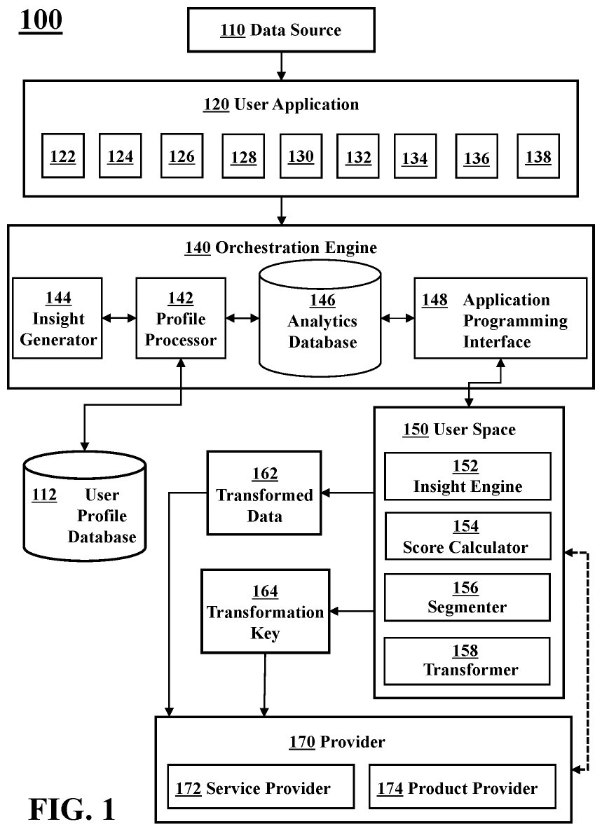

FIG. 1 illustrates an orchestration flow 100 of representative components of a system in accordance with embodiments of the present disclosure.

One or more data sources 110 provide information to a user application 120. A data source 110 may be any source of data such as, for example, manual entry of data by a user, an automatic pull of data by a program, duplication of data submitted to another application, or other data source. Data may include information from or concerning various aspects of a user. Data may include, for example, preferences 122, purchase history 124, social adapters 126, interne of things information 128, decision models 130, evaluation models 132, big data analytics 134, prescriptive analytics 136, data garnered via machine learning 138, or similar.

The user application 120 may provide data to an orchestration engine 140. The orchestration engine 140 may communicate with other information sources such as a user profile database 112. Communication with other data sources may be in addition to or instead of communication with the user application 120. Information may be compiled in a profile processor 142 and may be analyzed by an insight generator 144. Analysis from the insight generator 144 may be submitted and/or stored in the profile processor 142. The profile processor 142 may communicate with an analytics database 146. The analytics database 146 may communicate with an application programming interface 148.

The orchestration engine 140 may communicate with a user space 150 such as a user device, user private cloud, space reserved for a user on a server, or similar. The orchestration engine 140 and/or the user application 120 may exist within or as part of the user space 150 (e.g., a program on a user device, or an application within a user cloud space) or independently (e.g., located on an independent computer terminal or on a web-based application accessible via a browser communicating over the internet).

The user space 150 may have an insight engine 152, a score calculator 154, a segmenter 156, and/or a transformer 158. The insight engine 152 may garner insights from information which may include information stored in the user space 150, information provided by the orchestration engine 140, and/or another source of information. The insight engine 152 may, for example, combine information from the analytics database 146 with information stored in the user space 150 to achieve insight. The insight engine 152 may derive one or more insights using a variety of information and information types including, but not limited to, data from a data source 110, insights from an insight generator 144, information from a user profile database 112, data stored within a user space 150, or some combination thereof.

The score calculator 154 may calculate one or more scores based on benefits of using data for personalization and/or the resource costs associated therewith. The score calculator 154 may calculate scores for an entire dataset, a component thereof, a compilation of datasets, a compilation of components of datasets, or some combination thereof.

The score calculator 154 may calculate benefit-to-resource scores. A benefit-to-resource score may be computed by calculating a user benefit and a resource cost, then dividing the user benefit by the resource cost to obtain the benefit-to-resource score. A benefit-to-resource score may also be referred to as a user benefit-to-resource cost ratio, a benefit-to-resource utility ratio, a benefit-to-cost score, a benefit-to-cost ratio, a benefit-cost score, a benefit-cost score, or similar term comparing a benefit to the resources required to obtain that benefit. The present disclosure primarily discusses the benefit-to-resource comparison as a score to facilitate ease as decimals are typically more intuitive than ratios which are frequently described with fractions; any expression of a quantifiable benefit-to-cost may be used in accordance with the present disclosure.

Calculating user benefits and resource costs may be done in any manner currently known or which may later be developed. The present disclosure discusses normalized values for user benefit and resource cost; values that are not normalized may also be used if and when appropriate. In some embodiments, the normalization of each value is on a scale with numerical values between zero (0) and one (1). Other normalizations of benefit and cost values may also be used such as, for example, normalizing a user benefit value and a resource cost value between one (1) and ten (10). In some embodiments, normalized benefit and cost values may be re-normalized; for example, in some embodiments, a user may provide feedback on a first normalized scale (e.g., 1-5) and it is renormalized to a second normalized scale (e.g., 0-1) for implementation into the benefit value and/or the benefit-to-cost score.

A benefit value, generally, is the value of the expected benefit from an action or project. A benefit value may also be a measurement of how important certain data is for a particular application. A benefit value may be calculated using automated, manual, or semi-automated approaches. An automated approach may, for example, identify the number of services of a particular type requesting certain data: the more requests for a certain data segment, the higher the benefit value. Alternatively, an individual may manually input a benefit value for specific data segments. A semi-automated approach may combine the automated and manual approaches such that a benefit value for data may be automatically calculated and a user may provide feedback to change the benefit valuation. Feedback may be explicit (e.g., input via a survey) or implicitly (e.g., collected based on actions and/or inactions of a user).

In some embodiments, the calculation of a semi-automated benefit value may be expressed as:

$${B}_{User} = ( \frac{{M}_{U s e r}}{{k}_{M}} ) + ( \frac{A \cdot f}{{k}_{A}} )$$

wherein B_{User} is the benefit value of a user, M_{User} is the manual input of the user, k_{M} is a normalizing constant for the manual input data, A is data collected automatically, k_{A} is a normalizing constant for the automatically collected data, and f is a correctional factor.

The correctional factor f may be based on feedback provided by the user. The correctional factor may impact an entire dataset (as indicated in the above equation) or may impact only parts of a dataset (such as one datapoint). An entire dataset may be minimized (e.g., if it is determined to be unhelpful) or maximized (e.g., it is exceptionally helpful). For example, a dataset may be unhelpful because it is anomalous, such as moving expenses rendering expense data collected during the move unhelpful for planning a standard monthly budget. A single data point may similarly be corrected for by minimizing or maximizing it; for example, a user may indicate that a certain purchase should not impact future recommendations because the purchase was a gift for another person.

In some embodiments, a user may select a method for calculating a benefit value. For example, a user may select whether the benefit value calculation is automated, manual, or semi-automated. In some embodiments, a user may select whether and how feedback is collected and implemented. For example, a user may indicate that only explicit feedback may be integrated into the automated benefit valuation process. In another example, a user may indicate that only implicit feedback may be collected. In some embodiments, a user may select both the type and amount of feedback collected (e.g., explicit feedback is limited to one survey per week and implicit feedback may only be collected on certain days during specified hours).

A resource cost value, generally, is the value of the expected cost of undertaking the action or project. A resource cost may be calculated by determining the resources required to collect, maintain, and/or transmit data. In some embodiments, the resource cost of collection may include the resources required to collect the data (e.g., the storage space required to store a collection program and the memory required to execute the program). In some embodiments, a resource cost value may be calculated by determining how much space the data requires for storage; for example, data requiring three megabytes of storage space will thus have a lower resource cost than data requiring five gigabytes of storage space. In some embodiments, a resource cost may be calculated by determining the bandwidth required to transmit the data.

In some embodiments, the calculation of a resource cost value may be expressed as:

$${R}_{Cost} = ( \frac{{M}_{C} + {M}_{S} + {M}_{E} + T}{{k}_{R}} )$$

wherein R_{Cost} is the resource cost, M_{C} is the memory required for data collection, M_{S} is the memory required for storing the data, M_{E} is the memory required for using the data, T is the transmission cost, and k_{R} is a normalizing constant for the resource cost.

A benefit-to-cost score combines the values of benefit and cost into a number which may be used to express the desirability of pursuing an action or project. A higher benefit-to-cost ratio indicates data which is preferable to preserve during data dimensionality reduction such that data loss is minimized during dimensionality reduction. For example, if a benefit value is high (e.g., 0.9 on a normalized 0-1 scale) and a resource cost is low (e.g., 0.1 on a normalized 0-1 scale), the benefit-to-cost score is relatively high (given the aforementioned numbers, 9) and thus may be given priority for preservation of data during dimensionality reduction. A lower benefit-to-cost ratio indicates data which is preferable to reduce during data dimensionality reduction to preserve resources. For example, if a benefit value is low (e.g., 0.1 on a normalized 0-1 scale) and a resource cost is high (e.g., 0.9 on a normalized 0-1 scale), the benefit-to-cost score is relatively low (given the aforementioned numbers, approximately 0.111) and thus may be prioritized for reduction during dimensionality reduction to reduce resource consumption.

Thresholds for what constitutes a high (or low, or moderate) benefit-to-cost score may vary between applications. For example, a system with limited storage space may require a higher benefit-to-cost score threshold (e.g., a minimum score of 8) for prioritizing data preservation over data reduction whereas a system using extensive product tailoring may require a lower benefit-to-cost score threshold (e.g., a minimum score of 2) for prioritizing data preservation during dimensionality reduction. Multiple thresholds may also be used; for example, a system may separate data into three tiers (e.g., a compression tier for benefit-to-cost scores below 3, a compaction only tier for benefit-to-cost scores between 3 and 9, and a non-compressed tier for benefit-to-cost scores greater than 9) such that the least important data to the application is condensed to preserve resources, the somewhat important data may be preserved while balancing resource cost, and the most important data to the application is preserved.

The calculation of a benefit-to-resource score may be expressed as:

$$S = \frac{{B}_{U s e r}}{{R}_{C o s t}}$$

wherein S is the benefit-to-resource score, B_{User} is the benefit to the user, and R_{Cost} is the resource cost.

Both as a practical matter and numerically, a resource cost may be negligible, but it cannot equal zero (0). As a practical matter, any data input, usage, or storage requires the use of at least some resource and therefore has a resource cost. Numerically, the benefit-to-cost score is undefined if the resource cost equals zero (0).

Data, benefit values, resource values, benefit-to-resource scores, and thresholds may be stored in a user space 150. The user space 150 may be any private or otherwise designated space a user owns, controls, and/or has access to. For example, a user space 150 may be a user device (e.g., the computer or smartphone of an individual user), a private cloud owned by a user (e.g., a private cloud owned by a company wherein the user is the company), or a designated space within a cloud (e.g., cloud storage space allocated to an account belonging to individual user).

In some embodiments, user data is selectively stored in a user space 150 (e.g., a private cloud or user device) to address resource constraints (e.g., memory or disk space limitations) by identifying a benefit-to-resource score for the user personal data and reducing the dimensionality of data in consideration of data loss proportional to the benefit-to-resource score.

A score calculator 154 may calculate scores for segments of datasets. A dataset may be segmented using a segmenter 156. The segmenter 156 may accept data and/or datasets from one or more sources, compile the data, and separate the data into segments. Segments may each contain a particular type of data. For example, the segmenter 156 may segment the data such that one segment contains user contact information, another contains user preferences, and another contains user interactions on social media. Segments may be broad categories, collections of fine details, or any other level of grouping. For example, the segmenter 156 may segment the data such that one segment contains the contact information of a user, another segment contains the clothes purchase history of a user, another segment contains clothes style preferences expressly indicated by the user, and another segment contains information related to reactions the user made to outfits posted on social media.

In some embodiments, the method may include segmenting the dataset into data segments and determining a weightage for each of the data segments. The weightage may be based on a semantic purpose of an analytics service. Some embodiments may also include enabling reduce-transformation intensities in the autoencoder architecture according to the weightage.

Data in the user space 150 may be transformed with a transformer 158. The transformer 158 may transform data, data segments, or some combination thereof. The user space 150 may deliver transformed data 162 and the affiliated transformation key 164 to a provider 170. The provider 170 may have requested the information; alternatively, the provider 170 may accept the information from the user space 150 without requesting the information. The provider 170 may offer services and/or products. The provider 170 may have multiple segments such as, for example, a service provider 172 and a product provider 174. Multiple sets of transformed data 162 and transformation keys 164 may be submitted to the provider 170 for the same or different purposes.

In some embodiments, a benefit-to-resource score exceeds a threshold and the autoencoder architecture is selected to minimize reconstruction loss.

In some embodiments, the method may include segmenting a dataset into data segments and computing a segment benefit-to-resource score for each of the data segments. Some embodiments may also include transforming the data segments into transformed data segments and streaming one or more of the transformed data segments to a content personalizer such as a provider 170.

In some embodiments, the method may include segmenting the dataset into data segments, computing a segment benefit-to-resource score for each of the data segments, selecting a segment autoencoder architecture for each of the data segments based on the segment benefit-to-resource scores, leveraging at least one of the segment autoencoder architectures to transform at least one of the data segments into at least one transformed data segments, and transforming at least one of the data segments. In some embodiments, at least one transformed data segment is streamed to a machine learning service which may be a provider 170.

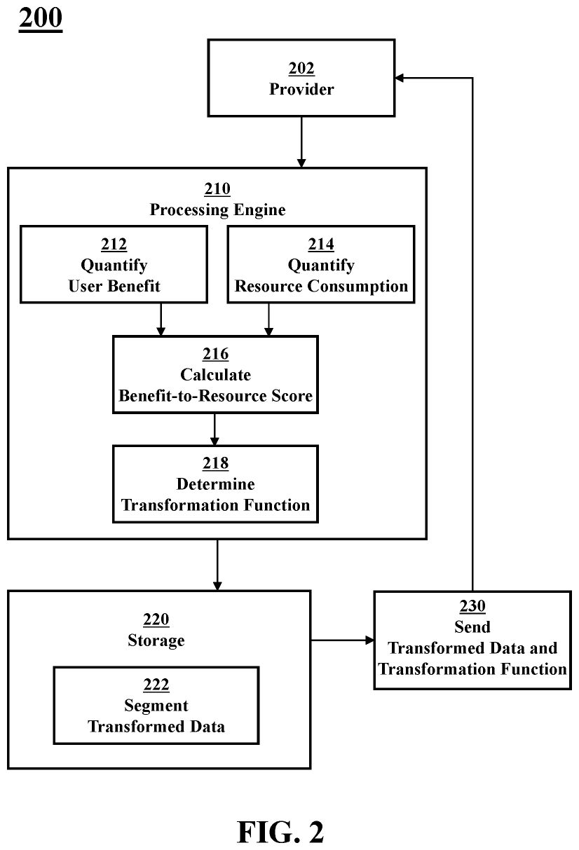

FIG. 2 depicts a privacy-driven data sharing method 200 in accordance with some embodiments of the present disclosure. A provider 202 may submit a request for information to a processing engine 210. The processing engine 210 may quantify 212 a user benefit value and quantify 214 a resource consumption value for the information requested by the provider 202. The processing engine 210 may calculate 216 a benefit-to-resource score for the requested information and determine 218 a transformation function for the information based on the benefit-to-resource score calculated therefor.

The processing engine 210 may send the transformed data and its transformation function(s) to storage 220. The storage 220 may segment 222 the transformed data. Alternatively, the transformed data may have previously been segmented, or the transformed data may not require segmentation. The transformed data and its transformation function may be sent 230 to the provider 202 in reply to the request.

Autoencoders may be used to encode and decode data. Any machine learning model may be used for data identification, segmentation, and/or transformation in accordance with the present disclosure. A well-trained machine learning model may minimize reconstruction loss using dimensional inputs. The autoencoders will have an autoencoder architecture based on deep learning model hyperparameters. Hyperparameters may include, for example, learning rate, mini-batch size, number of hidden layers, number of hidden units, number of epochs, and activation functions, as well as other hyperparameters known or which may later be discovered.

An autoencoder architecture may determine or guide the selection of a transformation function based on a utility score. The autoencoder architecture may include an acceptable amount of data loss based on a utility score. For example, a benefit-to-cost score may indicate that the loss of up to 10% of data on a particular data segment is acceptable; the transformation function may thus enable data compression with a loss of up to 10% of the compressed data segment. An autoencoder architecture may allow loss of some data on certain data segments (e.g., a segment with a low benefit-to-resource score) while preserving data on other data segments (e.g., a segment with a high benefit-to-resource score).

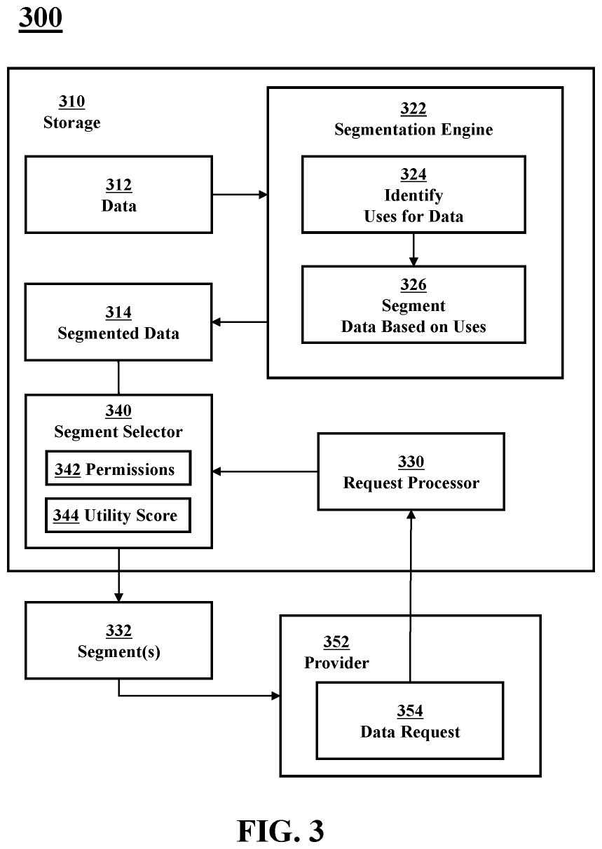

FIG. 3 illustrates a privacy-driven data sharing system 300 in accordance with some embodiments of the present disclosure. A privacy-driven data sharing system 300 may include storage 310 containing a segmentation engine 322, a request processor 330, and a segment selector 340. The storage 312 may contain data 312 which may be segmented by the segmentation engine 322. The segmentation engine 322 may identify 324 uses for the data and segment 326 the data based on the uses. The data 312 may thus be partitioned into segmented data 314.

A provider 352 may submit a data request 354 to the request processor 330. The request processor 330 may communicate with the segment selector 340 about the request. The segment selector 340 may select segments from the segmented data 314 to respond to the data request 354. The segment selector 340 may select one or more segment(s) 332 of data from the segmented data 314 to submit to the provider 352 to respond to the data request 354.

The segment selector 340 may assess whether segments should be submitted to the provider 352 based on various factors such as permissions 342 granted by a user and the utility score 344 calculated for the data segments. Permissions 342 may include, for example, a check to ensure a user permits certain data segments to be released, whether to any provider or the specific provider 352 requesting the information. A utility score 344 may be, for example, a benefit-to-cost score; a utility score 344 may indicate the alignment of a data segment with the data request (e.g., how relevant a data segment is to a particular data request 354).

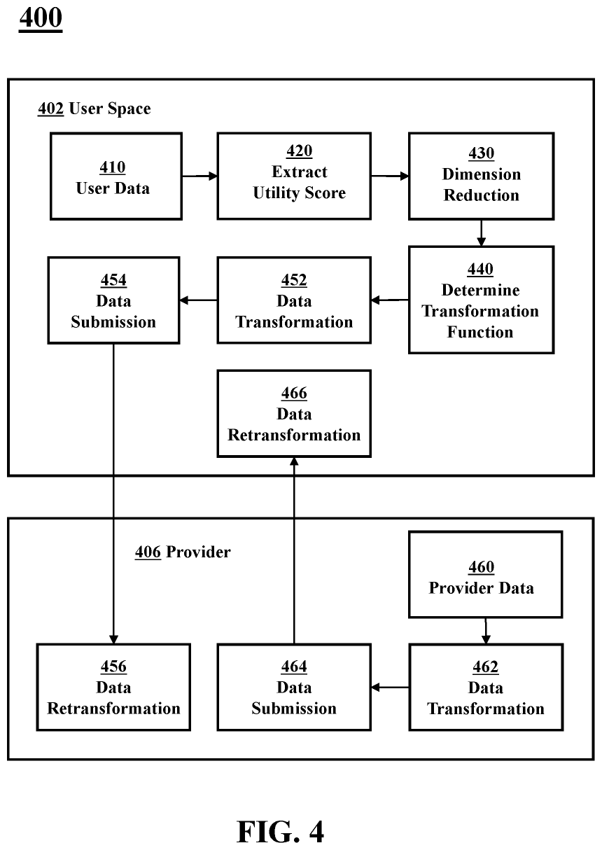

FIG. 4 depicts a data sharing method 400 using reduction in accordance with some embodiments of the present disclosure. The data sharing method 400 includes user data 410 maintained in a user space 402. A utility score may be extracted 420. The utility score may be extracted 420 using a variety of tools; for example, a consumer insight as a service (CIAAS) may extract 420 the utility score. A utility score may be, for example, a benefit-to-resource score, a pertinence calculation that quantifies the relevance of data to a particular query, or similar.

Dimension reduction 430 may occur; the dimension reduction 430 may depend on the extracted 420 utility score. A transformation function may be determined 440 based on the extracted 420 utility score and/or the desired dimension reduction 430. The user data 410 may be transformed 452 using the determined 440 transformation function. The transformed data may be submitted 454 to a provider 406.

The provider 406 may retransform 456 the data to garner insights from the data. The provider 406 may offer provider data 460 to a user via the user space 402. The provider data 460 may be transformed 462 and submitted 464 or submitted 464 without transformation 462. The provider 406 may use the same operations as a user (e.g., the provider 406 may extract a utility score, determine a preferred dimension reduction, and determine a transformation function). The provider 406 may submit untransformed data to a user space 402. Transformed data submitted to the user space 402 may then be retransformed 466. Data retransformation 456 and 466 may take place in a user space 402, a provider space, or outside of both spaces.

In some embodiments, the method may include enabling dimensionality reduction based on explainable machine learning. In some embodiments, the autoencoder architecture is additionally based on dominant features extracted from Shapley additive explanations analysis.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

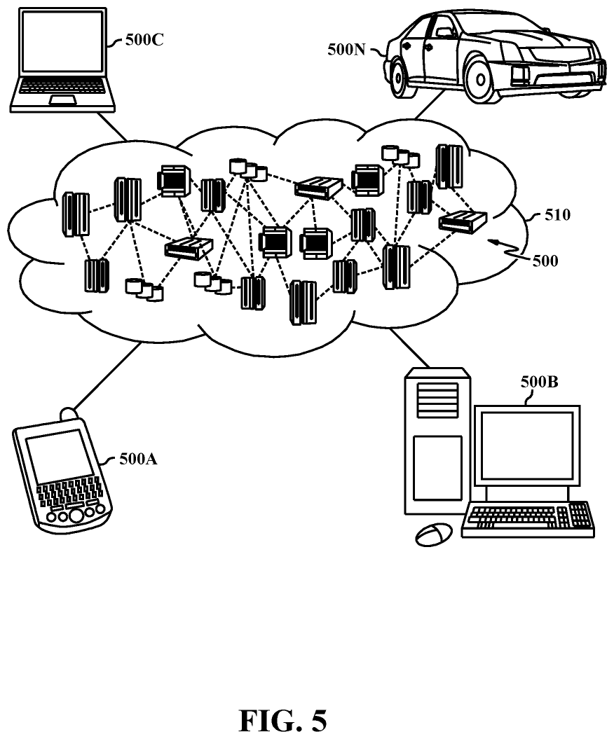

FIG. 5 illustrates a cloud computing environment 510 in accordance with embodiments of the present disclosure. As shown, cloud computing environment 510 includes one or more cloud computing nodes 500 with which local computing devices used by cloud consumers such as, for example, personal digital assistant (PDA) or cellular telephone 500A, desktop computer 500B, laptop computer 500C, and/or automobile computer system 500N may communicate. Nodes 500 may communicate with one another. They may be grouped (not shown) physically or virtually, in one or more networks, such as private, community, public, or hybrid clouds as described hereinabove, or a combination thereof.

This allows cloud computing environment 510 to offer infrastructure, platforms, and/or software as services for which a cloud consumer does not need to maintain resources on a local computing device. It is understood that the types of computing devices 500A-N shown in FIG. 5 are intended to be illustrative only and that computing nodes 500 and cloud computing environment 510 can communicate with any type of computerized device over any type of network and/or network addressable connection (e.g., using a web browser).

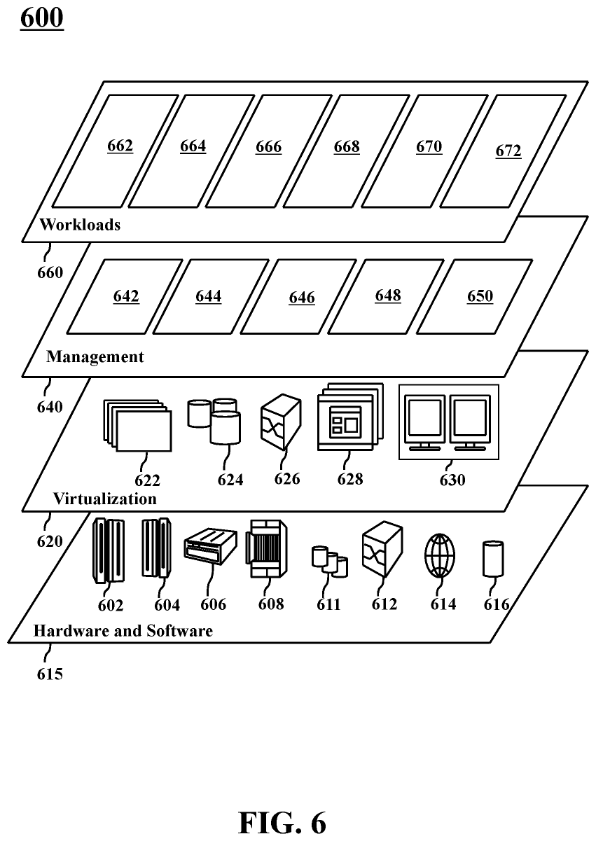

FIG. 6 illustrates abstraction model layers 600 provided by cloud computing environment 510 (of FIG. 5) in accordance with embodiments of the present disclosure. It should be understood in advance that the components, layers, and functions shown in FIG. 6 are intended to be illustrative only and embodiments of the disclosure are not limited thereto. As depicted below, the following layers and corresponding functions are provided.

Hardware and software layer 615 includes hardware and software components. Examples of hardware components include: mainframes 602; RISC (Reduced Instruction Set Computer) architecture-based servers 604; servers 606; blade servers 608; storage devices 611; and networks and networking components 612. In some embodiments, software components include network application server software 614 and database software 616.

Virtualization layer 620 provides an abstraction layer from which the following examples of virtual entities may be provided: virtual servers 622; virtual storage 624; virtual networks 626, including virtual private networks; virtual applications and operating systems 628; and virtual clients 630.

In one example, management layer 640 may provide the functions described below. Resource provisioning 642 provides dynamic procurement of computing resources and other resources that are utilized to perform tasks within the cloud computing environment. Metering and pricing 644 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 646 provides access to the cloud computing environment for consumers and system administrators. Service level management 648 provides cloud computing resource allocation and management such that required service levels are met. Service level agreement (SLA) planning and fulfillment 650 provide pre-arrangement for, and procurement of, cloud computing resources for which a future requirement is anticipated in accordance with an SLA.

Workloads layer 660 provides examples of functionality for which the cloud computing environment may be utilized. Examples of workloads and functions which may be provided from this layer include: mapping and navigation 662; software development and lifecycle management 664; virtual classroom education delivery 666; data analytics processing 668; transaction processing 670; and one or more cognitive frameworks for privacy-driven user data sharing 672.

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or which may be later developed.

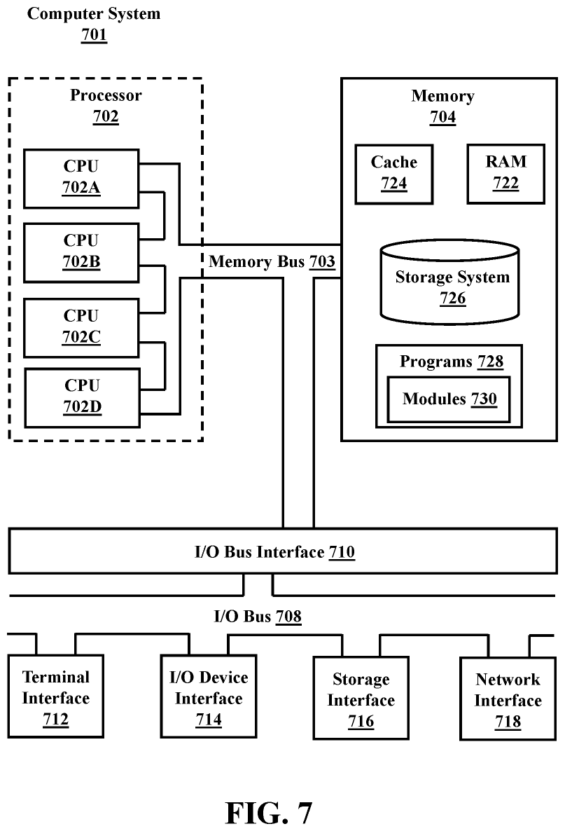

FIG. 7 illustrates a high-level block diagram of an example computer system 701 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 701 may comprise a processor 702 with one or more central processing units (CPUs) 702A, 702B, 702C, and 702D, a memory subsystem 704, a terminal interface 712, a storage interface 716, an I/O (Input/Output) device interface 714, and a network interface 718, all of which may be communicatively coupled, directly or indirectly, for inter-component communication via a memory bus 703, an I/O bus 708, and an I/O bus interface unit 710.

The computer system 701 may contain one or more general-purpose programmable CPUs 702A, 702B, 702C, and 702D, herein generically referred to as the CPU 702. In some embodiments, the computer system 701 may contain multiple processors typical of a relatively large system; however, in other embodiments, the computer system 701 may alternatively be a single CPU system. Each CPU 702 may execute instructions stored in the memory subsystem 704 and may include one or more levels of on-board cache.

System memory 704 may include computer system readable media in the form of volatile memory, such as random access memory (RAM) 722 or cache memory 724. Computer system 701 may further include other removable/non-removable, volatile/non-volatile computer system storage media. By way of example only, storage system 726 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 704 can include flash memory, e.g., a flash memory stick drive or a flash drive. Memory devices can be connected to memory bus 703 by one or more data media interfaces. The memory 704 may include at least one program product having a set (e.g., at least one) of program modules that are configured to carry out the functions of various embodiments.

One or more programs/utilities 728, each having at least one set of program modules 730, may be stored in memory 704. The programs/utilities 728 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 728 and/or program modules 730 generally perform the functions or methodologies of various embodiments.

Although the memory bus 703 is shown in FIG. 7 as a single bus structure providing a direct communication path among the CPUs 702, the memory subsystem 704, and the I/O bus interface 710, the memory bus 703 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 710 and the I/O bus 708 are shown as single respective units, the computer system 701 may, in some embodiments, contain multiple I/O bus interface units 710, multiple I/O buses 708, or both. Further, while multiple I/O interface units 710 are shown, which separate the I/O bus 708 from various communications paths running to the various I/O devices, in other embodiments some or all of the I/O devices may be connected directly to one or more system I/O buses 708.

In some embodiments, the computer system 701 may be a multi-user mainframe computer system, a single-user system, a server computer, or similar device that has little or no direct user interface but receives requests from other computer systems (clients). Further, in some embodiments, the computer system 701 may be implemented as a desktop computer, portable computer, laptop or notebook computer, tablet computer, pocket computer, telephone, smartphone, network switches or routers, or any other appropriate type of electronic device.

It is noted that FIG. 7 is intended to depict the representative major components of an exemplary computer system 701. In some embodiments, however, individual components may have greater or lesser complexity than as represented in FIG. 7, components other than or in addition to those shown in FIG. 7 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modification thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system for privacy-driven data sharing, said system comprising:
a memory; and
a processor in communication with said memory, said processor being configured to perform operations comprising:
computing a benefit-to-resource score for a dataset;
selecting an autoencoder architecture based on said benefit-to-resource score wherein said autoencoder architecture balances minimizing reconstruction loss and minimizing required storage space based on said benefit-to-resource score;
transforming said dataset into transformed data with a transformation function based on said autoencoder architecture; and
storing said transformed data in a user space.

2. The system of claim 1 wherein said operations further comprise:
segmenting said dataset into data segments;
computing a segment benefit-to-resource score for each of said data segments;
transforming said data segments into transformed data segments; and
streaming one or more of said transformed data segments to a content personalizer.

3. The system of claim 1 wherein said operations further comprise:
segmenting said dataset into data segments;
determining a weightage for each of said data segments wherein said weightage is based on a semantic purpose of an analytics service; and
enabling reduce-transformation intensities in said autoencoder architecture according to said weightage.

4. The system of claim 1 wherein said operations further comprise:
segmenting said dataset into data segments;
computing a segment benefit-to-resource score for each of said data segments;
selecting a segment autoencoder architecture for each of said data segments based on said segment benefit-to-resource scores;
leveraging at least one of said segment autoencoder architectures to transform at least one of said data segments into at least one transformed data segments; and
transforming said at least one of said data segments.

5. The system of claim 4 wherein:
at least one transformed data segment is streamed to a machine learning service.

6. The system of claim 1 wherein said operations further comprise:
enabling dimensionality reduction based on explainable machine learning.

7. The system of claim 1 wherein:
said autoencoder architecture is additionally based on dominant features extracted from Shapley additive explanations analysis.

8. The system of claim 1 wherein:
said benefit-to-resource score exceeds a threshold and said autoencoder architecture is selected to minimize reconstruction loss.

9. A method for privacy-driven data sharing, said method comprising:
computing, by a processor, a benefit-to-resource score for a dataset;
selecting an autoencoder architecture based on said benefit-to-resource score wherein said autoencoder architecture balances minimizing reconstruction loss and minimizing required storage space based on said benefit-to-resource score;
transforming said dataset into transformed data with a transformation function based on said autoencoder architecture; and
storing said transformed data in a user space.

10. The method of claim 9 further comprising:
segmenting said dataset into data segments;
computing a segment benefit-to-resource score for each of said data segments;
transforming said data segments into transformed data segments; and
streaming one or more of said transformed data segments to a content personalizer.

11. The method of claim 9 further comprising:
segmenting said dataset into data segments;
determining a weightage for each of said data segments wherein said weightage is based on a semantic purpose of an analytics service; and
enabling reduce-transformation intensities in said autoencoder architecture according to said weightage.

12. The method of claim 9 further comprising:
segmenting said dataset into data segments;
computing a segment benefit-to-resource score for each of said data segments;
selecting a segment autoencoder architecture for each of said data segments based on said segment benefit-to-resource scores;
leveraging at least one of said segment autoencoder architectures to transform at least one of said data segments into at least one transformed data segments; and
transforming at least one of said data segments.

13. The method of claim 12 wherein:
at least one transformed data segment is streamed to a machine learning service.

14. The method of claim 9 further comprising:
enabling dimensionality reduction based on explainable machine learning.

15. The method of claim 9 wherein:
said autoencoder architecture is additionally based on dominant features extracted from Shapley additive explanations analysis.

16. The method of claim 9 wherein:
said benefit-to-resource score exceeds a threshold and said autoencoder architecture is selected to minimize reconstruction loss.

17. A computer program product for privacy-driven data sharing, said computer program product comprising a computer readable storage medium having program instructions embodied therewith, said program instructions executable by a processor to cause said processor to perform a function, said function comprising:
computing, by said processor, a benefit-to-resource score for a dataset;
selecting an autoencoder architecture based on said benefit-to-resource score wherein said autoencoder architecture balances minimizing reconstruction loss and minimizing required storage space based on said benefit-to-resource score;
transforming said dataset into transformed data with a transformation function based on said autoencoder architecture; and
storing said transformed data in a user space.

18. The computer program product of claim 17 wherein:
said benefit-to-resource score exceeds a threshold and said autoencoder architecture is selected to minimize reconstruction loss.

19. The computer program product of claim 17, wherein said function further comprises:
segmenting said dataset into data segments;
computing a segment benefit-to-resource score for each of said data segments;
selecting a segment autoencoder architecture for each of said data segments based on said segment benefit-to-resource scores;
leveraging at least one of said segment autoencoder architectures to transform at least one of said data segments into at least one transformed data segments; and
transforming said at least one of said data segments.

20. The computer program product of claim 17 wherein:
segmenting said dataset into data segments;
computing a segment benefit-to-resource score for each of said data segments;
transforming said data segments into transformed data segments; and
streaming one or more of said transformed data segments to a content personalizer.
